(19) United States
(12) Patent Application Publication
(10) Pub. No.: US 2013/0063019 A1
(43) Pub. Date: Mar. 14, 2013

(54) VACUUM WINDOW WITH EMBEDDED INFORMATION DISPLAY

(71) Applicants: Jin Woo JEONG, Daejeon (KR); Yoon Ho SONG, Daejeon (KR); Sungyoul CHOI, Ulsan (KR); Jun Tae KANG, Daegu (KR); Jae-Woo KIM, Daejeon (KR)

(72) Inventors: Jin Woo JEONG, Daejeon (KR); Yoon Ho SONG, Daejeon (KR); Sungyoul CHOI, Ulsan (KR); Jun Tae KANG, Daegu (KR); Jae-Woo KIM, Daejeon (KR)

(73) Assignee: ELECTRONICS AND TELECOMMUNICATIONS RESEARCH INSTITUTE, Daejeon (KR)

(21) Appl. No.: 13/595,507

(22) Filed: Aug. 27, 2012

(30) Foreign Application Priority Data
Sep. 9, 2011 (KR) 10-2011-0092044

(51) Int. Cl. H01J 63/04; B82Y 99/00

(52) U.S. Cl. 313/496; 977/939

(57) ABSTRACT

Disclosed are a semiconductor apparatus and a manufacturing method thereof. The manufacturing method of the semiconductor apparatus includes: forming a semiconductor chip on a semiconductor substrate; adhering a carrier wafer with a plurality of through holes onto the semiconductor chip; polishing the semiconductor substrate; forming a first via hole at the rear side of the polished semiconductor substrate; forming a first metal layer below the polished semiconductor substrate and at the first via hole; and removing the carrier wafer from the polished semiconductor substrate.

### CROSS-REFERENCE TO RELATED APPLICATIONS

This application is based on and claims priority from Korean Patent Application No. 10-2011-0092044, filed on Sep. 9, 2011, with the Korean Intellectual Property Office, the disclosure of which is incorporated herein in its entirety by reference.

### TECHNICAL FIELD

The present disclosure relates to a vacuum window, and more particularly, to a vacuum window with an embedded information display by using a principle of a field emission display.

### BACKGROUND

Recently, cases where outer walls of houses and buildings are constructed by using glass for the elegant exterior of a building have increased. In the case of the glass outer walls, heat efficiency of the building is deteriorated due to incidence of direct light or interior heat loss through the glass behind the esthetic beauty. In order to supplement the drawback of the glass outer wall or glass window, a dual or triple layer window, in which a film or a dry air or vacuum layer is formed within single glass, is introduced.

FIGS. 1 and 2 illustrate a perspective view and a cross-sectional view of a vacuum window in the related art, respectively.

Referring to FIGS. 1 and 2, a vacuum window 100 in the related art is manufactured, in which the circumference of a space in which a spacer 140 is disposed between twofold plate windows 110 and 120 is sealed with a sealing member 130 to be sealed in vacuum, and inner air thereof is exhausted through an exhaust tube 150 which is formed at one side plate glass to be in a depressurized state.

In the vacuum window 100 in the related art, since the vacuum layer is formed between the two plate glasses 110 and 120, the structure is similar to a field emission display. The field emission display is a device of displaying information by using light generated when electrons emitted from a field emission emitter such as a carbon nanotube (CNT) are accelerated toward an anode electrode to collide with a phosphor.

Accordingly, the present disclosure provides a vacuum window with an embedded information display by adding the structure of the field emission display of the vacuum window in the related art.

### SUMMARY

The present disclosure has been made in an effort to provide a vacuum window which displays information on a glass wall or a glass window by adding a structure of a field emission display to the vacuum window for insulation of a building.

An exemplary embodiment of the present disclosure provides a vacuum window with an embedded information display, including: a first plate glass; a second plate glass installed to face the first plate glass; a sealing material configured to seal a space between the first plate glass and the second plate glass to be maintained in a vacuum state; a spacer inserted between the first plate glass and the second plate glass to separate the first plate glass and the second plate glass; a cathode electrode formed in a horizontal line form at the inside of the second plate glass and including a field emission emitter emitting electrons; and an anode electrode formed in a vertical line form at the inside of the first plate glass and including a phosphor generating light by the electrons emitted from the field emission emitter.

According to the exemplary embodiment of the present disclosure, it is possible to manufacture a vacuum window with an embedded information display through a field emission principle, by providing the vacuum window to which a structure of a field emission display is added.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are a perspective view and a cross-sectional view of a vacuum window in the related art, respectively.

FIGS. 3 and 4 are a plan view and a side view of a vacuum window with an embedded information display according to an exemplary embodiment of the present disclosure, respectively.

FIG. 5 is a diagram for describing a display principle of a vacuum window with an embedded information display according to the exemplary embodiment of the present disclosure.

FIG. 6 is a diagram for describing an implementation example of a color dot matrix of a vacuum window according to the exemplary embodiment of the present disclosure.

FIG. 7 is a diagram illustrating a case where a dot matrix is formed in some regions of a vacuum window according to the exemplary embodiment of the present disclosure.

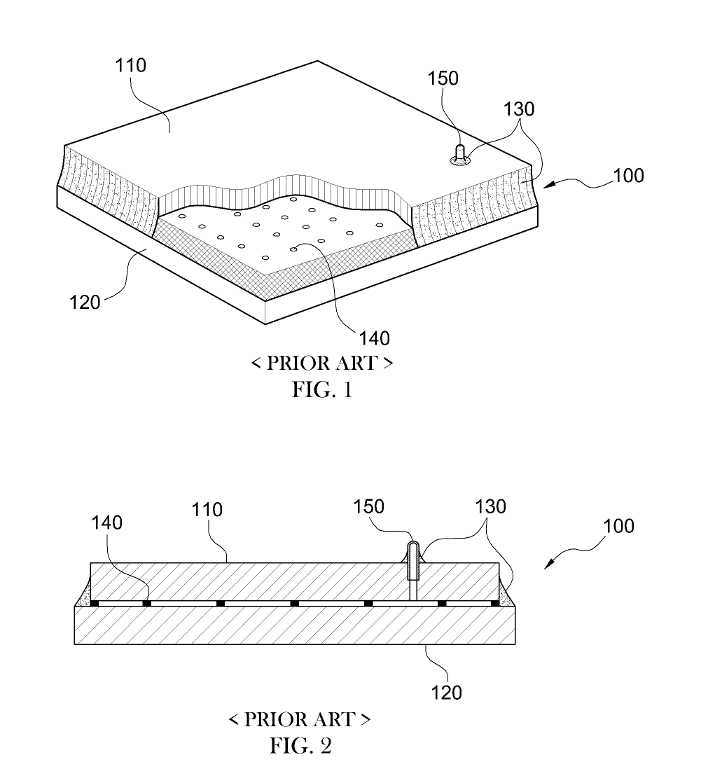

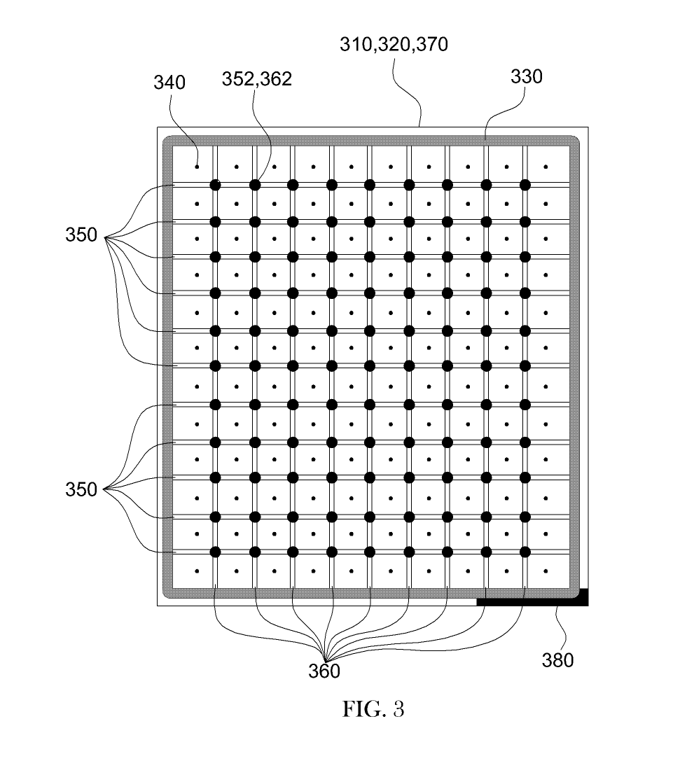

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail with reference to the accompanying drawings. In describing the present disclosure, well-known functions or constructions will not be described in detail since they may unnecessarily obscure the understanding of the present disclosure.

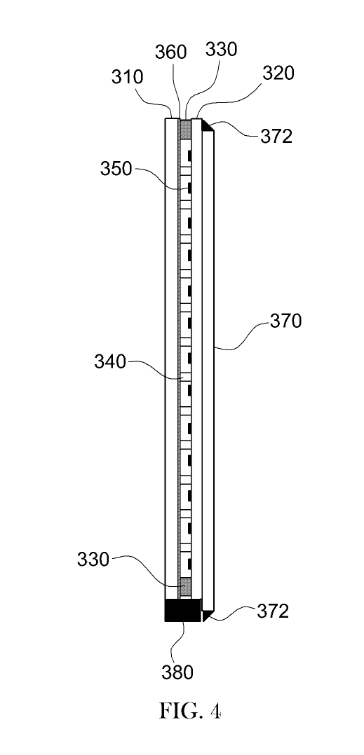

FIGS. 3 and 4 are a plan view and a side view of a vacuum window with an embedded information display according to an exemplary embodiment of the present disclosure, respectively.

Referring to FIGS. 3 and 4, the vacuum window according to the exemplary embodiment of the present disclosure includes a first plate glass 310, a second plate glass 320, a sealing material 330, a spacer 340, a cathode electrode 350, an anode electrode 360 and the like. Herein, the first plate glass 310 and the second plate glass 320 are disposed to face each other.

The sealing material 330 seals a space between the first plate glass 310 and the second plate glass 320 to be maintained in a vacuum state. To this end, the sealing material 330 may be made of a glass frit material.

The spacer 340 is inserted between the first plate glass 310 and the second plate glass 320 to separate the first plate glass and the second plate glass. Herein, the spacer 340 may be formed with a predetermined thickness so that the first plate glass 310 or the second plate glass 320 is not deformed or damaged by air pressure.

The cathode electrode 350 is formed in a horizontal line form at the inside of the second plate glass 320 and includes a field emission emitter 352 emitting electrons.

The anode electrode 360 is formed in a vertical line form at the inside of the first plate glass 310 and includes a phosphor 362 generating light by the electrons emitted from the field emission emitter 352.

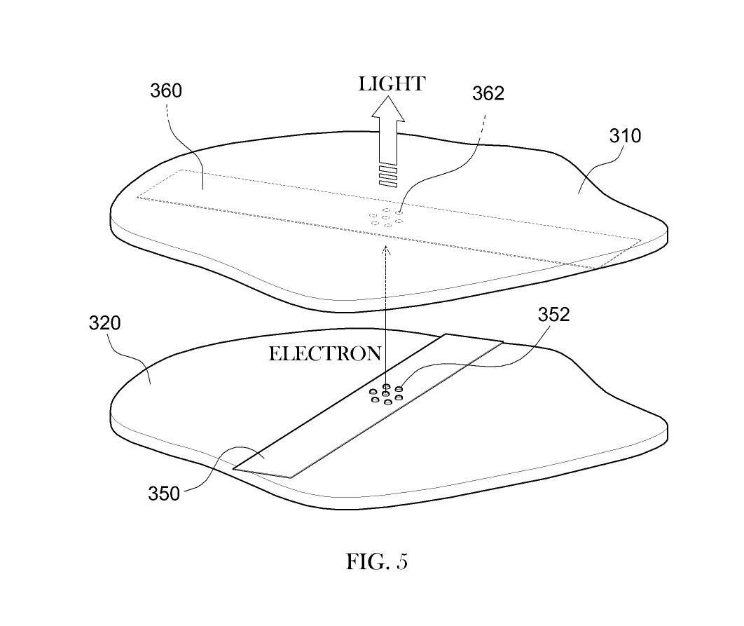

That is, as illustrated in FIG. 5, the vacuum window according to the exemplary embodiment of the present disclosure is configured by a structure in which the field emission emitter 352 and the phosphor 362 are formed at a point where the anode electrode 360 and the cathode electrode 350 meet, and thus the electrons emitted from the field emission emitter 352 reach the phosphor 362 to generate light, when sufficient magnitude of voltage is applied to the anode electrode 360 as compared with the cathode electrode 350. In this case, each dot configured by the field emission emitter 352 and the phosphor 362 may be variously displayed by a sequential dot matrix driving method.

The field emission emitter 352 may use a nano field emitter such as a carbon nanotube (CNT).

The phosphor 362 may use a vacuum fluorescent display (VFD) phosphor which does not require high voltage, but may also use a general cathode luminescence (CL) phosphor in the case where the voltage may be properly applied.

The vacuum window according to the exemplary embodiment of the present disclosure may further include a third plate glass 370 which is installed to face the second plate glass 320, in order to improve mechanical strength and insulation performance. Herein, the third plate glass 370 may be coupled with the second plate glass 320 by using a sealing agent 372. Inert gas such as argon, xenon, krypton and the like is injected between the second plate glass 320 and the third plate glass 370.

The vacuum window according to the exemplary embodiment of the present disclosure may further include a controller 380 which is electrically connected with the cathode electrode 350 formed at the second plate glass 320 and the anode electrode 360 formed at the first plate glass 310, in order to control display information. Herein, the controller 380 is directly installed at the vacuum window or installed at a means covering the vacuum window such as window frames to be electrically connected with the cathode electrode 350 and the anode electrode 360. The controller 380 includes a wireless communication module (not shown) to allow an operator to change the display information.

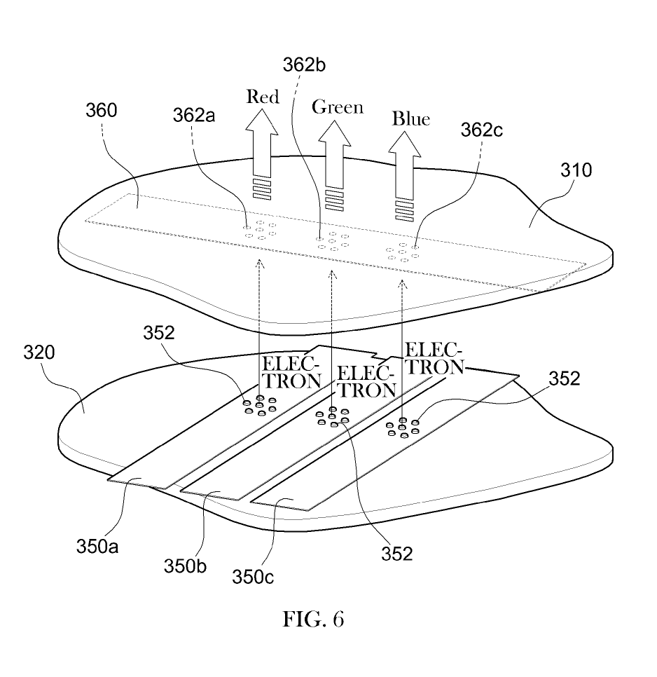

FIG. 6 is a diagram for describing an implementation example of a color dot matrix of a vacuum window according to the exemplary embodiment of the present disclosure.

As illustrated in FIG. 6, in the vacuum window according to the exemplary embodiment of the present disclosure, red, green and blue phosphors 362a, 362b and 362c are configured to be adjacent to each other and cathode electrodes 350a, 350b, 350cs with a field emission emitter 352 corresponding thereto are installed, such that it is possible to implement a color dot matrix by a color combination.

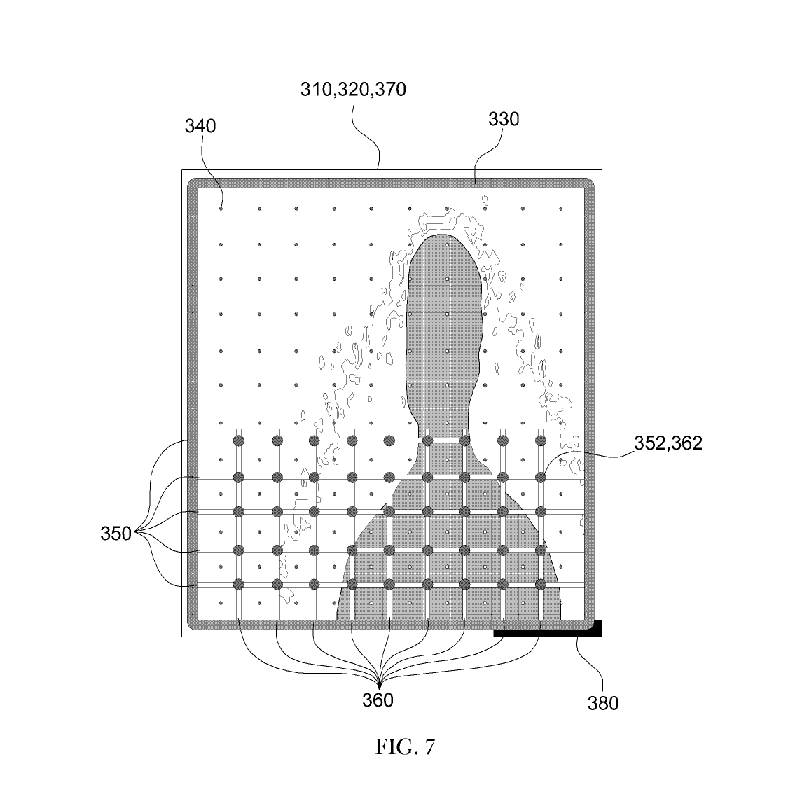

FIG. 7 is a diagram illustrating a case where a dot matrix is formed in some regions of a vacuum window according to the exemplary embodiment of the present disclosure.

As illustrated in FIG. 7, the vacuum window according to the exemplary embodiment of the present disclosure may be configured so as not to obstruct a sight by maintaining transparent glass in the rest regions except for the regions with the dot matrix by forming the dot matrix only in some regions.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A vacuum window with an embedded information display, comprising:
a first plate glass;
a second plate glass installed to face the first plate glass;
a sealing material configured to seal a space between the first plate glass and the second plate glass to be maintained in a vacuum state;
a spacer inserted between the first plate glass and the second plate glass to separate the first plate glass and the second plate glass;
a cathode electrode formed in a horizontal line form at the inside of the second plate glass and including a field emission emitter emitting electrons; and
an anode electrode formed in a vertical line form at the inside of the first plate glass and including a phosphor generating light by the electrons emitted from the field emission emitter.

2. The vacuum window with an embedded information display of claim 1, wherein the field emission emitter is a carbon nanotube (CNT).

3. The vacuum window with an embedded information display of claim 1, wherein the phosphor is a vacuum fluorescent display (VFD) phosphor or a cathode luminescence (CL) phosphor.

4. The vacuum window with an embedded information display of claim 1, wherein the phosphor is a phosphor having any one color of red, green and blue.

5. The vacuum window with an embedded information display of claim 1, further comprising:
a third plate glass installed to face the second plate glass.

6. The vacuum window with an embedded information display of claim 5, wherein the third plate glass is coupled with the second plate glass by using a sealing agent.

7. The vacuum window with an embedded information display of claim 5, wherein inert gas including any one of argon, xenon and krypton is injected between the second plate glass and the third plate glass.

8. The vacuum window with an embedded information display of claim 1, wherein the vacuum window configures a dot matrix by using the field emission emitter and the phosphor.

9. The vacuum window with an embedded information display of claim 8, wherein the dot matrix is formed in some regions of the vacuum window.

10. The vacuum window with an embedded information display of claim 1, further comprising:
a controller connected electrically with the anode electrode and the cathode electrode to control display information.

11. The vacuum window with an embedded information display of claim 10, wherein the controller includes a wireless communication module.

12. The vacuum window with an embedded information display of claim 10, wherein the controller is installed at the vacuum window or a means covering the vacuum window.
